(19) United States
(12) Patent Application Publication
(10) Pub. No.: US 2008/0079542 A1
(43) Pub. Date: Apr. 3, 2008

(54) Radio frequency identification (RFID) carrier and system

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/527,085

(22) Filed: Sep. 26, 2006

(51) Int. Cl. H04Q 5/22

(52) U.S. Cl. 340/10.1; 340/572.7; 340/10.4

(57) ABSTRACT

An RFID carrier includes a receive module, an oscillation module, a transmit module, and a power source module. The receive module is coupled to recover signaling information from an RFID signal to produce recovered signaling information. The oscillation module is coupled to generate at least one oscillation based on the recovered signaling information. The transmit module is coupled to convert the recovered signaling information into a repeat RFID signal based on an oscillation of the at least one oscillation. The power source module is coupled to provide at least one supply voltage to at least one of the receive module, the oscillation module, and the transmit module.

### CROSS REFERENCE TO RELATED PATENTS

NOT APPLICABLE

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to wireless communication systems and more particularly to radio frequency identification (RFID) systems.

2. Description of Related Art

A radio frequency identification (RFID) system generally includes a reader, also known as an interrogator, and a remote tag, also known as a transponder. Each tag stores identification data for use in identifying a person, article, parcel or other object. RFID systems may use active tags that include an internal power source, such as a battery, and/or passive tags that do not contain an internal power source, but instead are remotely powered by the reader.

Communication between the reader and the remote tag is enabled by radio frequency (RF) signals. In general, to access the identification data stored on an RFID tag, the RFID reader generates a modulated RF interrogation signal designed to evoke a modulated RF response from a tag. The RF response from the tag includes the coded identification data stored in the RFID tag. The RFID reader decodes the coded identification data to identify the person, article, parcel or other object associated with the RFID tag. For passive tags, the RFID reader also generates an unmodulated, continuous wave (CW) signal to activate and power the tag during data transfer.

RFID systems typically employ either far-field technology, in which the distance between the reader and the tag is great compared to the wavelength of the carrier signal, or near-field technology, in which the operating distance is less than one wavelength of the carrier signal, to facilitate communication between the RFID reader and RFID tag. In far-field applications, the RFID reader generates and transmits an RF request signal via an antenna to all tags within range of the antenna. One or more of the tags that receive the RF signal responds to the reader using a backscattering technique in which the tags modulate and reflect the received RF signal. In near-field applications, the RFID reader and tag communicate via mutual inductance between corresponding reader and tag inductors.

Accordingly, for a reader to obtain the desired information from a tag, the tag must be within a coverage area of the reader for the tag to receive the request and the reader must be in the coverage area of the tag to receive the response. Typically, the coverage area of a tag is less than that of the reader (e.g., a radius of about two meters). As such, to provide an RFID system throughout a substantial geographic area (e.g., an office building, an office complex, airport, shopping center, a cattle ranch, a forest preserve, etc.) a large number of readers are needed.

Currently, RFID readers are formed of separate and discrete components whose interfaces are well-defined. For example, an RFID reader may consist of a controller or microprocessor implemented on a CMOS integrated circuit and a radio implemented on one or more separate CMOS (complimentary metal oxide semiconductor), BiCMOS or GaAs (Gallium Arsenide) integrated circuits that are uniquely designed for optimal signal processing in a particular technology (e.g., near-field or far-field). However, the high cost of such discrete-component RFID readers has been a deterrent to wide-spread deployment of RFID systems.

Therefore, a need exists for a low cost RFID system that can be economically deployed in a substantial geographic area.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a diagram of an RFID system in accordance with the present invention;

FIG. 2 is a schematic block diagram of an RFID communication in accordance with the present invention;

FIG. 3 is a schematic block diagram of an embodiment of an RFID carrier in accordance with the present invention;

FIG. 4 is a schematic block diagram of an embodiment of a received module and a transmit module of an RFID carrier in accordance with the present invention;

FIG. 5 is a diagram illustrating the functionality of a blocking circuit and envelope detection module of an RFID carrier in accordance with the present invention;

FIG. 6 is a schematic block diagram of another embodiment of a received module and a transmit module of an RFID carrier in accordance with the present invention;

FIGS. 7 through 10 are logic diagrams of various methods of operations of an RFID carrier in accordance with the present invention; and

FIG. 11 is a schematic block diagram of an embodiment of an RFID tag in accordance with the present invention.

### DETAILED DESCRIPTION OF THE INVENTION

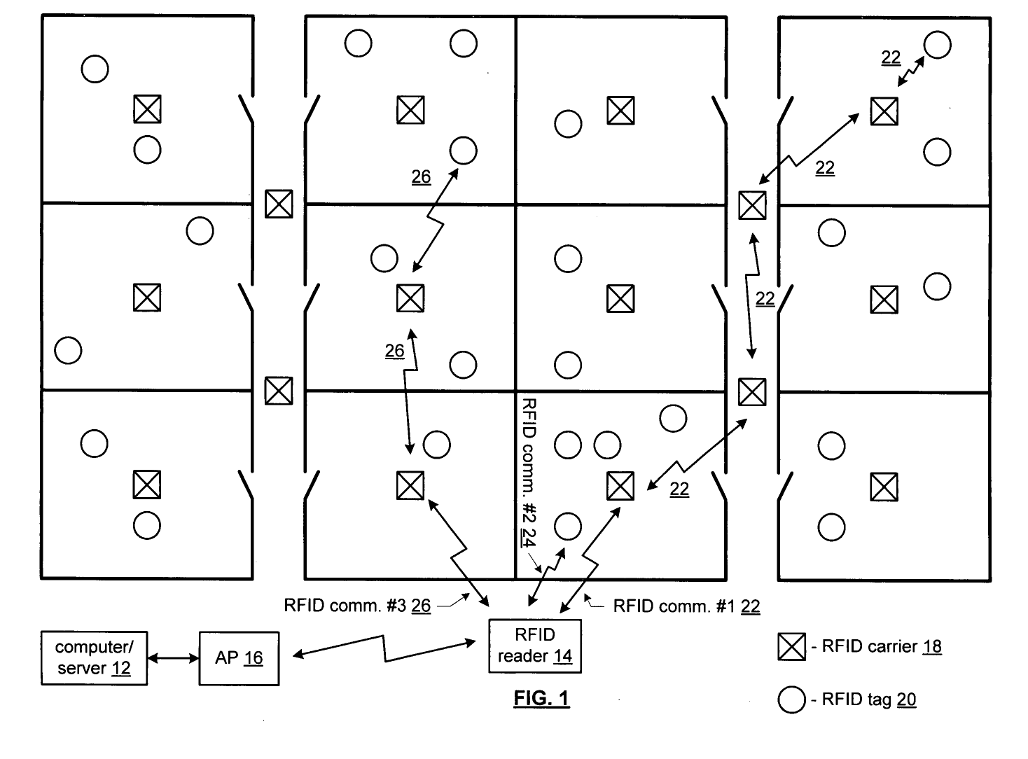

FIG. 1 is a diagram of a radio frequency identification (RFID) system that includes a computer/server 12, at least one RFID reader 14, at least one access point (AP) 16, a plurality of RFID carriers 18; and a plurality of RFID tags 20. In this illustration, the plurality of RFID carriers 18 is distributed throughout a plurality of rooms and hallways of a building. Note that this illustration may be for an entire building, portion of the building, portion of a floor of a building. Alternatively, the RFID carriers 18 may be distributed throughout any geographic area such as a cattle ranch, airport, forest preserve, national park, etc. Further note that the RFID carriers 18 may be placed in a fixed local with respect to the geographic area such that RFID tags within the geographic area are within the coverage area of at least one RFID carrier 18.

The RFID reader 14 may be a stationary or mobile device. For example, if the RFID reader 14 is a stationary device, it may be incorporated within the access point 16 and position within the geographic area to provide a desired coverage area. Alternatively, the RFID reader 14 may be implemented in a handheld device that a user may carry through the hallways of the example building or through any other geographic area.

In operation, the reader 14 transmits an RFID request to one or more tags 20. If the addressed tag 20 is within the coverage area of the RFID reader, the tag interprets the request and provides the appropriate response. This is illustrated in FIG. 1 via a 2^{nd} RFID communication 24. In this instance, the RFD tag is close enough to the RFID reader 14 to provide direct communication there between.

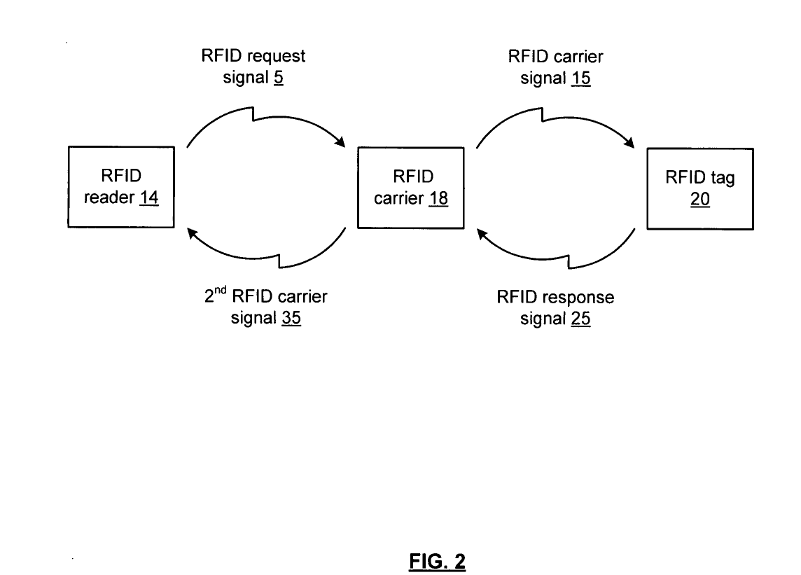

If, however, the addressed tag 20 is not within the direct coverage area of the RFID reader 14, one or more RFID carriers 18 relays the requests to the tag and also relays the corresponding response back to the reader 14. For example, a 1^{st} RFID communication 22 has the tag 20 outside of the immediate coverage area of the RFID reader 14. In this example, four RFID carriers 18 provide the communication link between the RFID reader 14 and the addressed tag 20. As yet another example, a 3^{rd} RFID communication 26 may address RIFD tag 20 in which two RFID carriers 18 support the communication between the reader and the corresponding tag. The functionality of the RFID carriers will be described in greater detail with reference to FIGS. 2 through 11.

FIG. 2 illustrates an RFID communication between an RFID reader 14 and an RFID tag 20 supported by an RFID carrier 18. In this example, the RFID reader 14 transmits an RIFD request signal 5, which is received by the RFID carrier 18. The request signal 5 may be a request for data contained within the RFID tag, a request for a computation to be performed by the RFID tag, a request to store data, a request to delete data, a request to update data and/or a combination thereof.

The RFID carrier 18 replicates the RFID request signal 5 and transmits it as an RFID carrier signal 15. The RFID tag 20 receives the RFID carrier signal 15 and produces therefrom a supply voltage to power circuitry of the tag. The circuitry of the tag interprets the message contained therein and generates an appropriate response, which may include the requested data and/or an acknowledgement that the requested computation, storing, deleting, and/or updating of data has been completed. The tag 20 then transmits the response as an RFID signal 25. The RFID carrier 18 receives the RFID response signal 25, replicates it, and transmits the replication as a second RFID carrier signal 35 to the reader 14. The reader 14 receives the second RFID carrier signal 35 and processes it accordingly.

In one embodiment, the RFID carrier 18 receives the RFID request signal 5 at a first carrier frequency and generates the replicated RFID request signal at a second frequency. For example, the first frequency may be 880 megahertz while the second frequency may be 920 megahertz. Thus, the two signals are still within a 900 megahertz frequency band but are offset to allow for better blocking of transmit signals within back-scattering devices such as the RFID carrier 18 and RFID tag 20. As an alternative embodiment, the RFID carrier 18 may use time division multiplexing to receive the RFID request signal 5 and to replicate it. This may be done using the same frequency or different frequencies as previously discussed.

In another embodiment, the RFID carrier 18 receives the RFID request signal at a first frequency and replicates the RFID request signal in accordance with a frequency hopping pattern to produce a replicated RFID request signal. The RFID carrier 18 then transmits the replicated RFID request signal as the RFID carrier signal.

In yet another embodiment, the RFID carrier 18 receives the RFID request signal at a first frequency and replicates the RFID request signal in accordance with a spread spectrum scheme to produce a replicated RFID request signal. The RFID carrier then transmits the replicated RFID request signal as the RFID carrier signal.

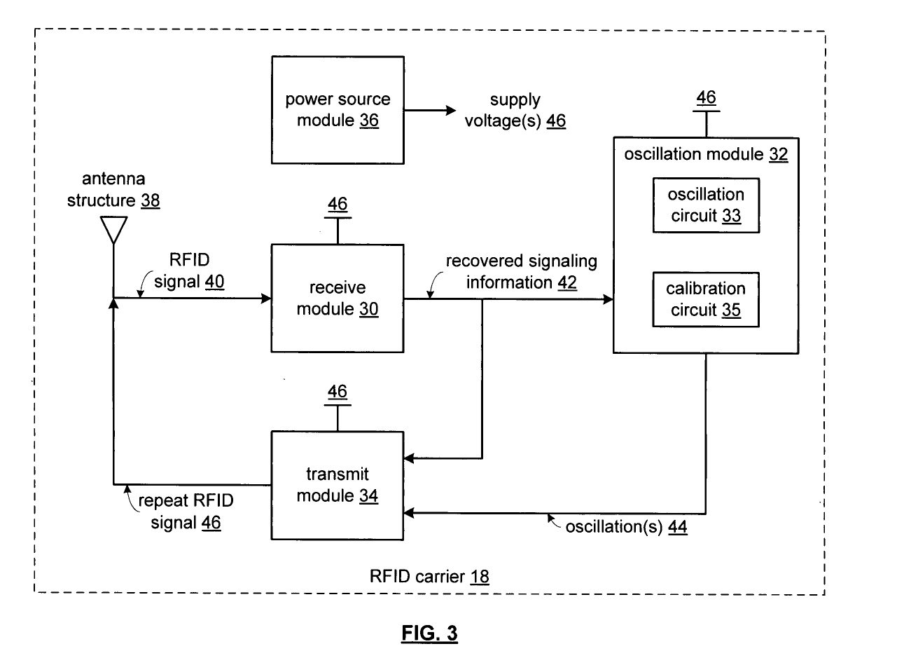

FIG. 3 is a schematic block diagram of an RFID carrier 18 that includes a receive module 30, an oscillation module 32, a transmit module 34, a power supply module 36, an antenna structure 38. The oscillation module 32 includes an oscillation circuit 33 and a calibration circuit 35. The antenna structure 38 may include one or more antennas having the same or different polarizations and/or a diversity antenna structure. In addition, the antenna structure may be shared between the transmit path and the receive path or it may include separate antennas for the transmit and receive paths.

In operation, the RFID carrier 18 receives an RFID signal 40 via the antenna structure 38. The RFID signal 40 may be a request from the RFID reader, a response from an RFID tag, or a repeat of a request or a response from another RFID carrier. The receiving module 30 converts the RFID signal 40 into recovered signaling information 42. At a minimum, the recovered signaling information 42 includes the identity of the source of the RFID signal, the destination of the RFID signal 40 and the corresponding message contained therein.

The oscillation module 32, via the oscillation circuit 33 and the calibration circuit 35, utilizes the recovered signaling information 42 to produce one or more oscillations 44, which may be used as a local oscillation for the transmit module 34. In one embodiment, the oscillation circuit 33 produces a reference oscillation approximately equal to the desired transmit local oscillation. The calibration circuit 35 adjusts the reference oscillation based on the recovered signaling information 42 to produce the desired oscillation 44. The one or more oscillations 44 may be a radio frequency oscillation corresponding to the carrier frequency of the RFID signal, a multiple of the RF oscillation corresponding to the carrier frequency of the RFID signal, an RF oscillation corresponding to the carrier frequency of the RFID signal plus an offset frequency, and/or a multiple of the RF oscillation corresponding to the carrier frequency of the RFID signal plus an offset frequency. Accordingly, the oscillation module 32 may generate a local oscillation having a frequency corresponding to the carrier frequency of the received RFID signal 40, a multiple thereof, the carrier frequency of the received RFID signal 40 (e.g., 900 MHz) plus or minus a frequency offset (eg. <=40 megahertz) and/or a multiple thereof.

The transmit module 34 converts the recovered signaling information 42 into a repeat RFID signal 46 based on the oscillation 44. In one embodiment, the recovered signaling information 42 is an amplitude modulation signal that is mixed with the oscillation 44 to produce the repeat RFID 46.

The power source module 36 is coupled to produce one or more supply voltages 46. In one embodiment, the power source module 36 includes a power generating circuit that is coupled to convert the RFID signal 40 into the supply voltage 46. In an alternative embodiment, the power source module 36 may include the power generating circuit, a solar cell, a photodiode array, and/or a battery to individually or collectively produce the supply voltage.

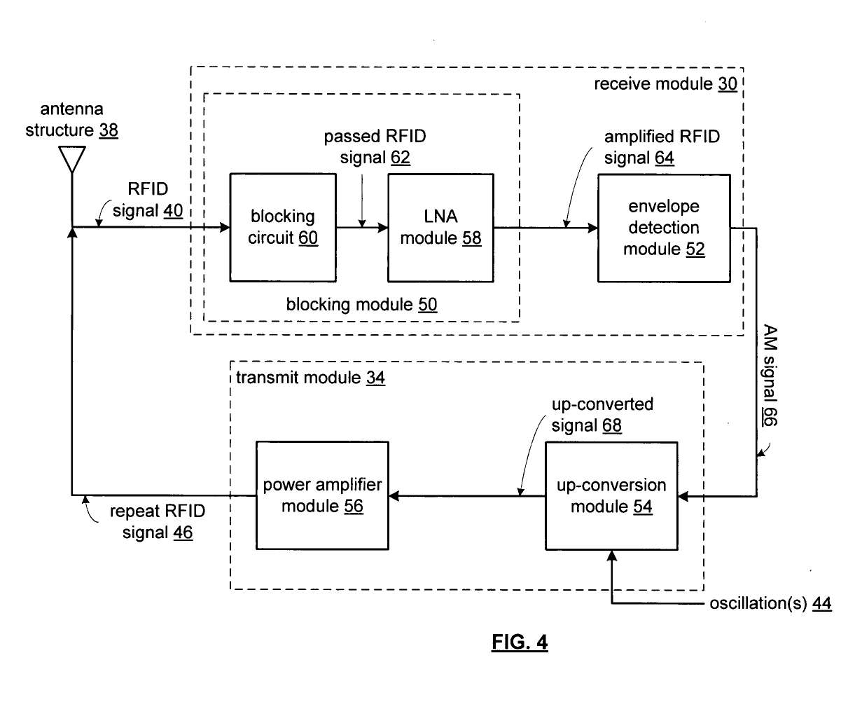

FIG. 4 is a schematic block diagram of an embodiment of a received module 30 and transmit module 34 of an RFID carrier 18. In this embodiment, the received module 30 includes a blocking module 50 and an envelope detection module 52. The blocking module 50 includes a blocking circuit 60 and low noise amplifier (LNA) module 58. The transmit module 34 includes an up conversion module 54 and a power amplifier module 56.

In operation, the blocking circuit 60 receives the RFID signal 40 and substantially attenuates the repeat RFID signal 46 and passes, substantially unattenuated, the RFID signal 40 as a passed RFID signal 62. The low noise amplifier module 58, which may include one or more low noise amplifiers, gain adjust module etc., amplifies the passed RFID signal 62 to produce an amplified RFID signal 64. The envelope detection module 52 determines an envelope waveform of the amplified RFID signal 64 to produce an amplitude modulated (AM) signal 66, which corresponds to the recovered signaling information 42.

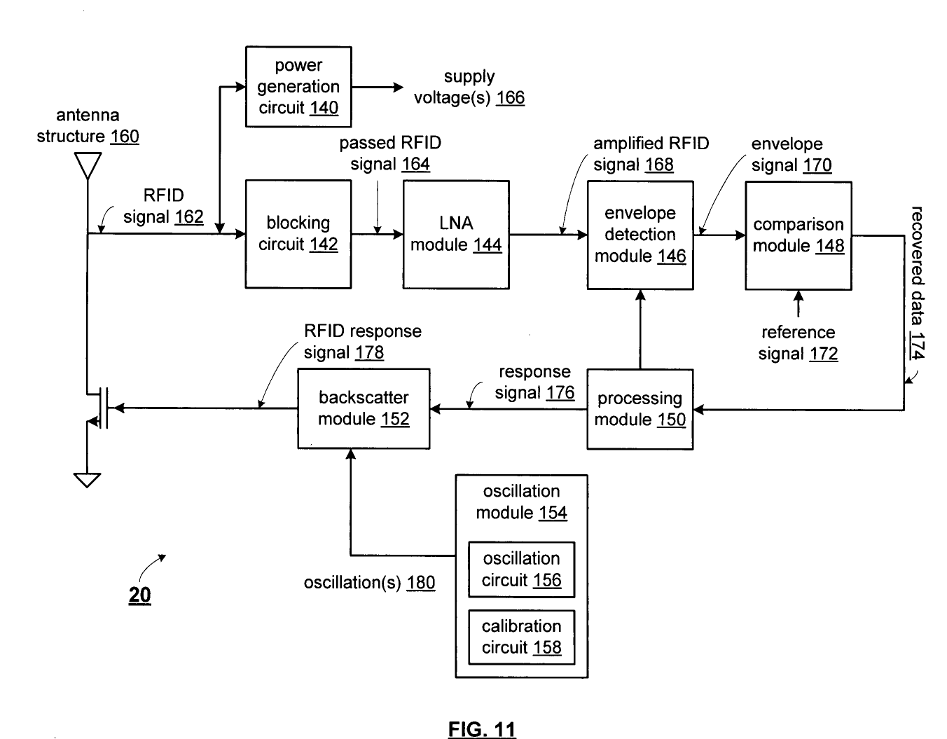

The up conversion module 54 which may include in phase and quadrature mixers, mixes the amplitude modulated signal 66 with the oscillation 44 to produce an up converted signal 68. The power amplifier module 56, which may include one or more power amplifiers, a gating transistor for back scattering transmission via the antenna structure 30, preamplifier modules etc., amplifies the up converted signal 68 to produce the repeat RIFD signal 46. Note that the up converted signal 68 may have the same carrier frequency as the received RFID signal 40 or may be at a different frequency. Further note that the architecture of the received module 30 and transmit module 34 are similar to that of an RFID tag, which is shown in FIG. 11. As such, the cost of an RFID carrier 18 is comparable to that of an RFID tag as oppose to an RFID reader. Accordingly, widespread deployment of a system that includes RFID carriers will be more economical than a system that uses readers only.

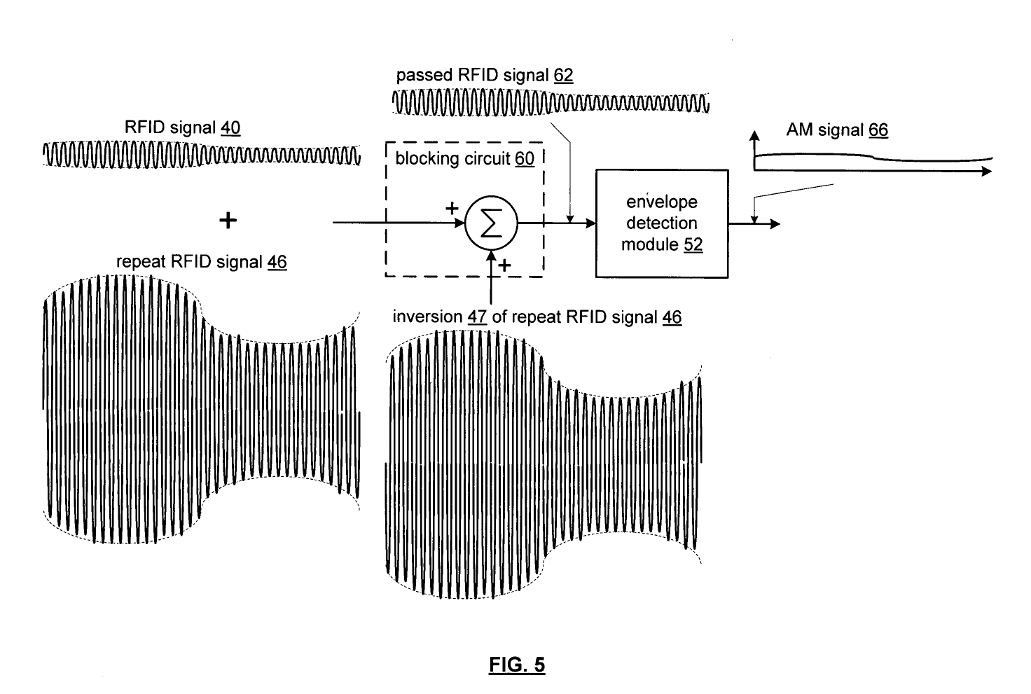

FIG. 5 illustrates the functionality of the receiver module 30. In this embodiment, the blocking circuit 60 includes an adding module and the low noise amplifier is admitted for simplification. The input of the blocking circuit 60 includes a summation of the RFID signal 40 and the repeat RFID signal 46. As shown, the magnitude of the repeat RFID signal 46 is significantly greater than the RFD signal 40 (eg. 40 dB or more). The second input of the blocking circuit 60 is an inversion 47 of the repeat RFID signal 46. As such, when the blocking circuit 60 adds the two signals, the passed RFID signal 62 corresponds to the RFID signal 40.

The envelope detection module 52 may filter the passed RFID signal 62 to produce the AM signal 66, or more may compare the RFID signal 62 with a threshold to produce the amplitude modulated signal 66.

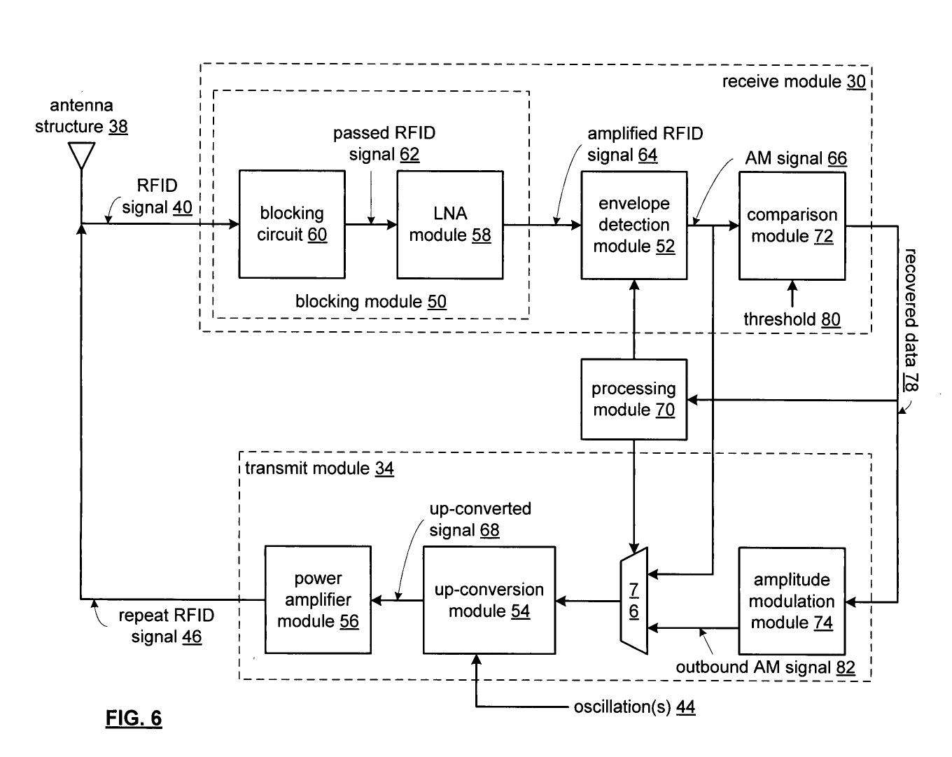

FIG. 6 is a schematic block diagram of another embodiment of the received module 30 and transmit module 34 of the RFID carrier 18. In this embodiment, the received module 30 includes the blocking module 50, the envelope detection module 52 and a comparison module 72. The transmit module 34 includes an amplitude modulation module 74, a multiplexer 76, via conversion module 54 and the power amplifier module 56. In addition, the RFID carrier 18 includes a processing module 70. The processing module 70 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module 70 may include or have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 70 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module 70 executes, hard coded and/or operational instructions corresponding to at least some of the steps and/or functions illustrated in FIGS. 6-10.

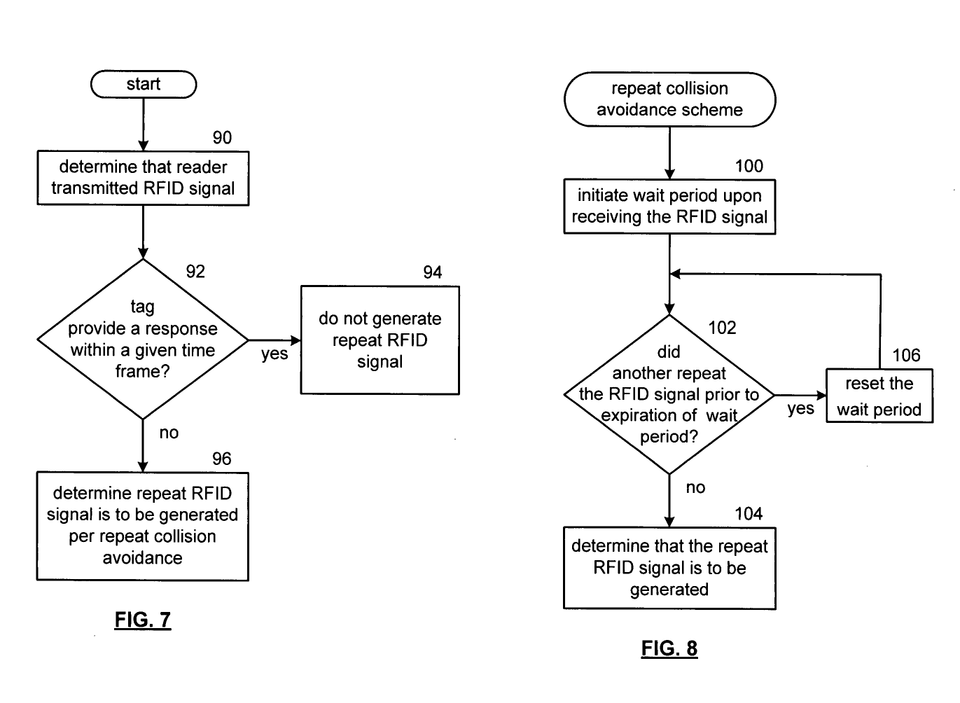

The blocking module 50 and envelope detection module 52 function as previously described to recover an amplitude modulated signal 66 from the received RFID signal 40 in the presence of the repeat RFID signal 46. The comparison module 72 is coupled to compare the amplitude modulated signal 66 with a threshold 80 to produce recovered data 78. The processing module 70 receives the recovered data 78 and interprets it to determine whether the repeat RFID signal is to be generated. This will be described in greater detail with reference to FIGS. 7 through 10.

If the transmit module 34 is to repeat the amplitude modulated signal 66, the processing module 70 enables multiplexer 76 to pass the amplitude modulated signal 66 to the up conversion module 54. The up conversion module 54 generates the up converted signal 68, which is amplified by the power amplifier module 56, to produce the repeat RFID signal 46. If, however, the processing module 70 determines that the recovered data 78 is to be repeated, the amplitude modulation module 74 converts the recovered data 78 into an outbound amplitude modulated signal 82. The processing module enables multiplexer 76 to pass the outbound amplitude modulated signal 82 to the up conversion module 54, which produces the up converted signal 68. Note that in one embodiment, the processing module 70 may disable the envelope detection module 52 when the repeat RFID signal 46 is being generated. Further note that the recovered data 78 may be stored in memory (not shown and/or contained within processing module 70) of the RFID carrier 18.

FIG. 7 is a logic diagram performed by processing module 70 that begins at step 90 where the carrier determines that a reader transmitted the RFID signal. The process then proceeds to step 92 where the carrier determines whether the tag provided a response within a given time frame (e.g., within a few seconds). If yes, the process proceeds to step 94 where the RFID carrier does not generate the repeat RFID signal. For example, with reference to FIG. 1, and the second RFID communication 24, the tag is within the coverage area of the RFID reader. As such, RFID carriers within the coverage area of the tag and/or of the reader 14 receive the request and also receive the response thus can determine that the request and response do not need to be repeated.

If, however, the tag did not provide a response within a given time frame, the process proceeds to step 96. At step 96, the carrier determines that the repeat RFID signal is to be generated in accordance with a repeat collision avoidance scheme. The repeat collision avoidance scheme may be one or more of token passing, a ring scheme, pseudo random number generation, and/or different frequency pattern usage. Once the collision avoidance scheme has been processed, the carrier generates the repeat RFID signal and transmits it.

FIG. 8 illustrates a method for processing repeat collision avoidance scheme. The process begins at step 100 where the carrier initiates a wait period upon receiving the RFID signal. The process then proceeds as step 102 where the carrier determines whether another RFID carrier repeated the RFID signal prior to expiration of the wait period. If yes, the process proceeds to step 106 where the carrier resets the wait period and continues the processing of step 102. Note that the resetting of the wait period may reset wait period and/or a different wait period using a pseudo random numbered generation scheme.

If another RFID carrier did not repeat the RIFD signal prior to the expiration of the wait period, the process proceeds to step 104 where the RFID carrier determines that the repeat RFID signal is to be generated and subsequently generates it.

FIGS. 9 is a logic diagram of another method performed by the processing module 70 of the RFID carrier. This process begins at step 110 where the carrier determines that the RFID signal was transmitted by a tag. At step 112, the carrier determines whether a request RFID signal from a RFID reader was repeated by the RIFD carrier. If not, the process proceeds to step 116 where the carrier does not repeat the tag's response signal. If, however, the carrier did repeat the request, the process proceeds to step 114 where the carrier determines that the repeat RFID signal is to be generated and then generates it.

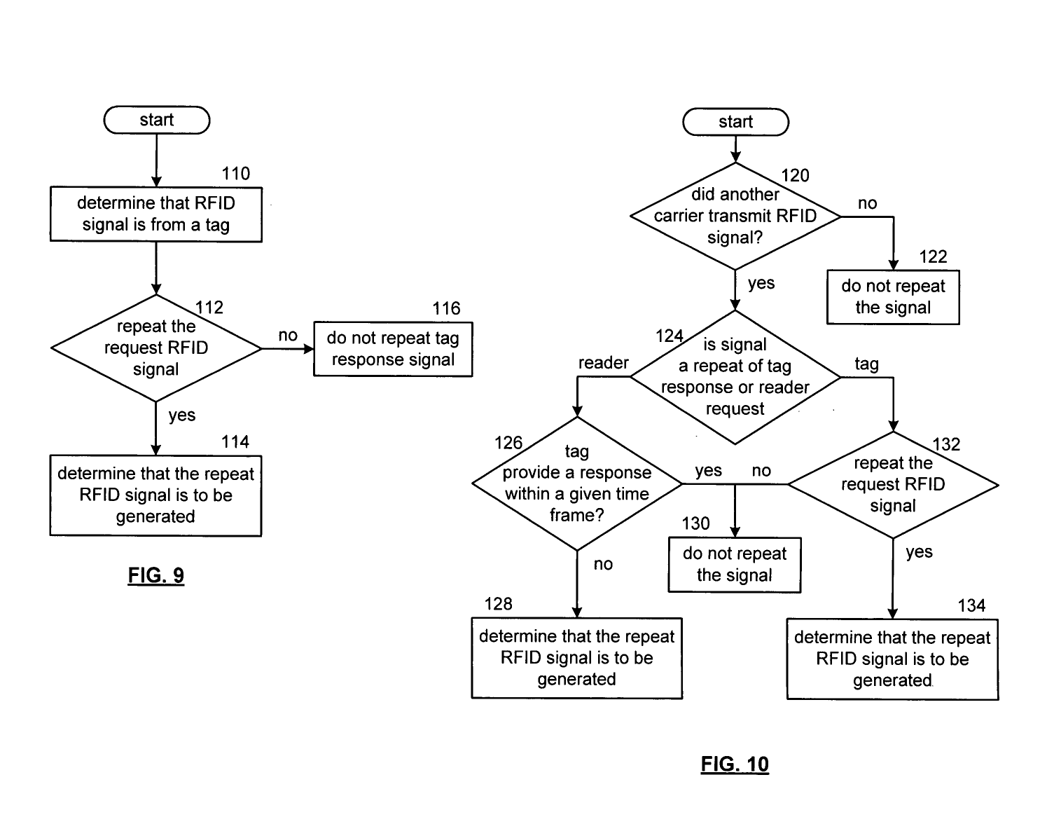

FIG. 10 is a logic diagram of another method performed by the processing module 70 of the RFID carrier. The process begins at step 120 where the carrier determines whether another RFID carrier transmitted the RFID signal. Note that the RFID signal may be an RFID request signal or an RFID response signal. If not, the process proceeds to step 122 where the carrier does not repeat the signal. If another carrier transmitted the RFID signal, the process proceeds to step 124 where the carrier determines whether the signal is a repeat of a tag response or a reader request. At step 132 the carrier determines whether it repeated the RFID request signal sent to the tag. If not, the process proceeds to step 130 where the carrier does not repeat the signal. If, however, the carrier repeated the request to the tag, then the process proceeds to step 134 where the RFID carrier determines that the repeat RFID signal is to be generated and generates it. In this instance the repeat RFID signal is a repeat of the RFID tags responses.

If the signal is a repeat of a reader request, the process proceeds to step 126 where the carrier determines whether a tag provided a response within a given timeframe. If yes, the process proceeds to step 130 and the signal is not repeated. If, however, a tag did not provide a response within a given timeframe, the process proceeds to step 128 where the carrier determines that the repeat RFID signal is to be generated and subsequently generates it as a repeat of the RFID request signal.

FIG. 11 is a schematic block diagram of an RFID tag that includes an antenna structure 160, a power generating circuit 140, a blocking circuit 142, a low noise amplifier module 144, an envelope detection module 146, a comparison module 148, a processing module 150, a back scatter 152, a oscillation module 154. The oscillation module 154 includes an oscillation circuit 156 and a calibration circuit 158. In operation, the antenna structure 160, which may be a single antenna multiple antennas with a diversity structure, the same polarization and/or different polarizations, receives an RFID signal 162. The power generation circuit 140 converts the RFID signal 162 into a supply voltage 166 that is used to supply power for the remaining modules and/or circuits of the RFID tag 20.

The blocking circuit 142 receives the RFID signal 162 and the RFID response signal 178 and the substantially attenuates the RFID response signal 178 such that the RFID signal 162 is provided as a pass RFID signal 164 to the low noise amplifier module 144. The low noise amplifier module 144, which may include one or more low noise amplifier, automatic gain control, and/or a gain adjust module, amplifies the passed RFID signal 164 to produce an amplified RFID signal 168.

The envelope detection module 146 generates an envelope signal 170 from the amplified RFID 168. The comparison module 148 compares the envelope signal 170 with a reference signal 172 to produce recovered data 174. The processing module 150 processes the recovered data 174 to produce a response signal 176, which may be an acknowledgement message that the request has been fulfilled and/or data can fulfillment of the request.

The back scattering module 152 based on one or more oscillations 180 generated by the oscillation module 154 converts the response signal 176 into the RFID response signal 178. In one embodiment, the back scattering module 152 includes a transistor coupled to the antenna structure 160 wherein the transistor is gated based on the response signal 176. In an embodiment of the oscillation module 154, the oscillation circuit 156 is coupled to produce a reference oscillation. The calibration circuit is coupled to adjust the referenced oscillation based on the recovered data 174 to produce the oscillation or oscillations 180. Note that the oscillation may be one or more of a radio frequency oscillation corresponded to a carrier frequency of the RFID signal, a multiple of the RFID oscillation corresponded to the carrier frequency of the RFID signal, an RF oscillation corresponded to the carrier frequency of the RFID signal plus an offset frequency, or a multiple of the RF oscillation corresponded to the carrier frequency of the RFID signal plus an offset frequency.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A radio frequency identification (RFID) carrier comprises:
a receive module coupled to recover signaling information from an RFID signal to produce recovered signaling information;
oscillation module coupled to generate at least one oscillation based on the recovered signaling information;
a transmit module coupled to convert the recovered signaling information into a repeat RFID signal based on an oscillation of the at least one oscillation; and
a power source module coupled to provide at least one supply voltage to at least one of the receive module, the oscillation module, and the transmit module.

2. The RFID carrier of claim 1 comprises:
the receive module including:
a blocking module coupled to substantially block the repeat RFID signal and to pass the RFID signal to produce a passed RFID signal; and
an envelope detection module coupled to recover an amplitude modulated signal from the passed RFID signal, wherein the amplitude modulated signal corresponds to the recovered signaling information; and
the transmit module including:
an up-conversion module coupled to up-convert the amplitude modulated signal based on the oscillation to produce an up-converted signal; and
a power amplifier module coupled to amplify the up-converted signal to produce the repeat RFID signal.

3. The RFID carrier of claim 2, wherein the blocking module comprises:
a blocking circuit coupled to substantially attenuate the repeat RFID signal and to substantially pass unattenuated the RFID signal to produce the passed RFID signal; and
a low noise amplifier module coupled to amplify the passed RFID signal to produce an amplified RFID signal.

4. The RFID carrier of claim 1 further comprises:
a processing module coupled to determine when the repeat RFID signal is to be generated.

5. The RFID carrier of claim 4 comprises:
the receive module including:
an envelope detection module coupled to recover an amplitude modulated signal from the passed RFID signal; and
a comparison module coupled to compare the amplitude modulated signal with a threshold to produce recovered data, wherein the processing module determines when the repeat RFID signal is to be generated based on the recovered data; and
the transmit module including:
an up-conversion module coupled to convert the amplitude modulated signal into an up-converted signal based on the oscillation; and
a power amplifier module coupled to amplify the up-converted signal to produce the repeat RFID signal.

6. The RFID carrier of claim 5, wherein the processing module further functions to disable the envelope detection module when the power amplifier module is amplifying the up-converted signal.

7. The RFID carrier of claim 5, wherein the receive section further comprises: a blocking module coupled to substantially block the repeat RFID signal and to pass the RFID signal to envelope detection module.

8. The RFID carrier of claim 4 comprises:
the receive module including:
an envelope detection module coupled to recover an amplitude modulated signal from the passed RFID signal; and
a comparison module coupled to compare the amplitude modulated signal with a threshold to produce recovered data, wherein the processing module determines when the repeat RFID signal is to be generated based on the recovered data; and
the transmit module including:
an amplitude modulation module coupled to convert the recovered data into an outbound amplitude modulated signal; and
an up-conversion module coupled to up-convert the outbound amplitude modulated signal based on the oscillation to produce an up-converted signal; and
a power amplifier module coupled to amplify the up-converted signal to produce the repeat RFID signal.

9. The RFID carrier of claim 4, wherein the determining when the repeat RFID signal is to be generated comprises:
determining that an RFID reader transmitted the RFID signal;
determining whether an RFID tag provided a response RFID signal within a given response time frame; and
when the RFID tag did not provided the response RFID signal within the given response time frame, determining that the repeat RFID signal is to be generated in accordance with a repeat collision avoidance scheme.

10. The RFID carrier of claim 9, wherein the in accordance with a repeat collision avoidance scheme comprises:
initiating a wait period upon receiving the RFID signal;
determining whether another RFID carrier repeat the RFID signal prior to expiration of the wait period; and
when the another RFID carrier did not repeat the RFID signal prior to expiration of the wait period, determining that the repeat RFID signal is to be generated.

11. The RFID carrier of claim 10 further comprises:
when the another RFID carrier did repeat the RFID signal prior to expiration of the wait period, resetting the wait period;
determining whether the RFID tag provided a response RFID signal to the repeat RFID signal of the another RFID carrier within the given response time frame; and
when the RFID tag did not provided the response RFID signal to the repeat RFID signal of the another RFID carrier within the given response time frame, determining that the repeat RFID signal is to be generated in accordance with the repeat collision avoidance scheme.

12. The RFID carrier of claim 9, wherein the in accordance with a repeat collision avoidance scheme comprises at least one of:
a token passing scheme;
a ring scheme; and
frequency pattern scheme.

13. The RFID carrier of claim 4, wherein the determining when the repeat RFID signal is to be generated comprises:
determining that an RFID tag transmitted the RFID signal;
determining whether a request RFID signal from an RFID reader was repeated by the RFID carrier; and
when the request RFID signal was repeated by the RFID carrier, determining that the repeat RFID signal is to be generated.

14. The RFID carrier of claim 4, wherein the determining when the repeat RFID signal is to be generated comprises:
determining that another RFID carrier transmitted the RFID signal;
determining whether the RFID signal is a repeat of an RFID tag response signal or a repeat of an RFID reader request signal;
when the RFID signal is a repeat of the RFID reader request signal, determining whether an RFID tag provided a response RFID signal within a given response time frame; and
when the RFID tag did not provided the response RFID signal within the given response time frame, determining that the repeat RFID signal is to be generated in accordance with a repeat collision avoidance scheme.

15. The RFID carrier of claim 14, wherein the determining when the repeat RFID signal is to be generated further comprises:
when the RFID signal is a repeat of the RFID tag response signal, determining whether a request RFID signal from an RFID reader was repeated by the RFID carrier; and
when the request RFID signal was repeated by the RFID carrier, determining that the repeat RFID signal is to be generated.

16. The RFID carrier of claim 1, wherein the oscillation module comprises:
an oscillation circuit coupled to produce a reference oscillation; and
a calibration circuit coupled to adjust the reference oscillation based on the recovered signaling information to produce the at least one oscillation, wherein the at least one oscillation includes one or more of: a radio frequency (RF) oscillation corresponding to a carrier frequency of the RFID signal, a multiple of the RF oscillation corresponding to the carrier frequency of the RFID signal, an RF oscillation corresponding to the carrier frequency of the RFID signal plus an offset frequency, and a multiple of the RF oscillation corresponding to the carrier frequency of the RFID signal plus an offset frequency.

17. The RFID carrier of claim 1, wherein the power source module comprises at least one of:
a power generating circuit coupled to convert the RFID signal into a supply voltage;
a solar cell;
a photodiode array circuit, and
a battery.

18. A radio frequency identification (RFID) system comprises:
an RFID reader coupled to generate an RFID request signal;
an RFID carrier coupled to generate an RFID carrier signal in response to the RFID request signal; and
an RFID tag coupled to generate an RFID response signal in response to the RFID request signal based on the RFID carrier signal.

19. The RFID system of claim 18, wherein the RFID carrier is further coupled to:
generate a second RFID carrier signal in response to the RFID response signal.

20. The RFID system of claim 18, wherein the RFID carrier is further coupled to:
receive the RFID request signal at a first frequency;
replicate the RFID request signal at a second frequency to produce a replicated RFID request signal; and
transmit the replicated RFID request signal as the RFID carrier signal.

21. The RFID system of claim 18, wherein the RFID carrier is further coupled to:
receive the RFID request signal at a first frequency; and
generate the RFID carrier signal at a second frequency.

22. The RFID system of claim 21, wherein the RFID tag is further coupled to:
convert the RFID carrier signal into a supply voltage;
provide the supply voltage to circuitry of the RFID tag for processing the RFID request signal; and
generate, via the circuitry of the RFID tag, the RFID response signal in response to the RFID request signal.

23. The RFID system of claim 18, wherein the RFID carrier is further coupled to:
receive the RFID request signal at a first frequency;
replicate the RFID request signal in accordance with a frequency hopping pattern to produce a replicated RFID request signal; and
transmit the replicated RFID request signal as the RFID carrier signal.

24. The RFID system of claim 18, wherein the RFID carrier is further coupled to:
receive the RFID request signal at a first frequency;
replicate the RFID request signal in accordance with a spread spectrum scheme to produce a replicated RFID request signal; and
transmit the replicated RFID request signal as the RFID carrier signal.

25. A radio frequency identification (RFID) tag comprises:
a power generation circuit coupled to produce a supply voltage from an RFID signal;
an envelope detection module coupled to generate an envelope signal from the RFID signal;
a comparison module coupled to compare the envelope signal with a reference signal to produce recovered data;
a processing module coupled to process the recovered data and, when required, prepare a response signal; and
a backscattering module coupled to transmit the response signal as an RFID response signal.

26. The RFID tag of claim 25 further comprises:
an oscillation module coupled to generate at least one oscillation, wherein the processing module is clocked based on the at least one oscillation.

27. The RFID tag of claim 26, wherein the oscillation module comprises:
an oscillation circuit coupled to produce a reference oscillation; and
a calibration circuit coupled to adjust the reference oscillation based on the recovered data to produce the at least one oscillation, wherein the at least one oscillation includes one or more of: a radio frequency (RF) oscillation corresponding to a carrier frequency of the RFID signal, a multiple of the RF oscillation corresponding to the carrier frequency of the RFID signal, an RF oscillation corresponding to the carrier frequency of the RFID signal plus an offset frequency, and a multiple of the RF oscillation corresponding to the carrier frequency of the RFID signal plus an offset frequency.

28. The RFID tag of claim 25, wherein the backscattering module comprises:
a transistor coupled to an antenna, wherein the antenna receives the RFID signal, and wherein the transistor is gated based on the response signal.
